(19) United States
(12) Patent Application Publication
(10) Pub. No.: US 2022/0152816 A1
(43) Pub. Date: May 19, 2022

(54) DECENTRALIZED ROBOTIC OPERATING ENVIRONMENT OPTIMIZATION

(71) Applicant: Intrinsic Innovation LLC, Mountain View, CA (US)

(72) Inventors: Mirko Bordignon, Munich (DE); Adam Nicholas Ruxton, Sunnyvale, CA (US)

(21) Appl. No.: 17/097,570

(22) Filed: Nov. 13, 2020

(51) Int. Cl. B25J 9/16

(52) U.S. Cl. CPC B25J 9/163

(57) ABSTRACT

Methods, systems, and apparatus, including computer programs encoded on computer storage media, for a system for decentralized and validated robotic planning. One of the methods includes obtaining data representing an optimization challenge for a task to be performed by one or more robots in a robotic operating environment, wherein the optimization challenge has one or more associated goal criteria for the task; providing, by the validation platform system to a development platform system operated by a different entity than the validation platform system, information related to the optimization challenge; obtaining a candidate robotic control plan; executing the candidate robotic control plan using the digital representation of the robotic operating environment; determining that the candidate robotic control plan is valid according to the one or more goal criteria; and in response, providing the valid robotic control plan for deployment in the robotic operating environment.

### BACKGROUND

This specification relates to robotics, and more particularly to planning robotic movements.

Robotics control refers to controlling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators.

Robotics planning has traditionally required immense amounts of manual programming in order to meticulously dictate how the robotic components should move in order to accomplish a particular task. Manual programming is tedious, time-consuming, and error prone. In addition, a schedule that is manually generated for one robotic operating environment can generally not be used for other robotic operating environments. In this specification, a robotic operating environment is the physical environment in which a robot will operate. Robotic operating environments have particular physical properties, e.g., physical dimensions that impose constraints on how robots can move within the robotic operating environment. Thus, a manually programmed schedule for one robotic operating environment may be incompatible with a robotic operating environment having different robots, a different number of robots, or different physical dimensions.

In addition, the majority of robotic operating environments are manually programmed by system integrators who have specialized, and often proprietary, knowledge regarding the robotic operating environment and the operations of the robots within the robotic operating environment. As a result, updates or improvements to operations of the robots within the robotic operating environment must be performed by highly specialized engineers, e.g., an onsite systems integrator. Further, in order to update and optimize a robotics plan for a robotic operating environment, the robots must typically cease operation to be manually reprogrammed.

As a result, performing updates or optimization to a robotic control plan for a robotic operating environment can be a time-consuming and expensive process due to the substantial overhead costs and downtime associated with the programming.

### SUMMARY

This specification generally describes a system for decentralized and validated robotic planning. The system can obtain and validate proposed solutions from developers for optimizing an operating metric of a robotic plan in a robotic operating environment. In particular, the specification describes a platform that can be used by operators of a robotic operating environment to submit an optimization challenge for a robotic operating environment to be solved through decentralized submissions of programming solutions. The platform can also be used to protect confidential aspects of the robotic operating environment. For example, the platform can automatically mask aspects of the robotic operating environment that should not be public e.g., what a product being produced looks like, what tooling is being used, or other types of proprietary and confidential information. The specification also describes how the platform can automatically validate one or more decentralized programming solutions for optimization challenges submitted by operators of the robotic operating environments.

In this specification, an optimization challenge is a collection of data defining a target improvement to a robotic process involving one or more robots. An optimization challenge comprises a representation of a robotic operating environment and a task in need of a valid solution. An optimization challenge can include one or more goal criteria that specify what qualifies as a valid solution for the task. Valid solutions are not guaranteed to exist for any particular goal criteria, and in the typical case, valid solutions are unknown when the optimization challenge is defined. For example, an optimization challenge can specify that the time it takes to perform a particular welding job should be reduced by 3 seconds. It is often difficult or impossible to know from the data of the optimization challenge whether or not a valid solution exists.

In this specification, a task refers to a capability of a particular robot that involves performing one or more subtasks. For example, a connector insertion task is a capability that enables a robot to insert a wire connector into a socket. This task typically includes two subtasks: 1) move a tool of a robot to a location of the socket, and 2) insert the connector into the socket at the particular location.

Particular embodiments of the subject matter described in this specification can be implemented so as to realize one or more of the following advantages.

The system allows for decentralized submission of solutions for optimizing a robotic process, which can reduce the time and cost of operating the robotic process in a robotic operating environment. For example, by soliciting a solution to optimize a robotic operating environment on a challenge-based, decentralized planning platform, an operations team can obtain improvements to a robotic process without the need of an onsite integrator, thus reducing the overall cost of optimizing the robotic operating environment. For example, a validated robotic plan for optimizing the robotic operating environment that is submitted to the platform could be passed directly to the robot hardware in the robotic operating environment through a manufacturing execution system (MES) for execution by the robots in the robotic operating environment.

In addition, by passing validated robotic control plans that optimize the robot planning directly to the robot hardware in the robotic operating environment through a control system, the robotic operating environment would not need to stop operations in order to implement optimized code. For example, an MES can receive an optimized robotic control plan from the platform, store the improved code on edge devices, such as programmable logic controllers (PLCs) and robot controllers, and then command a switchover to the improved code at the appropriate time in the robotic plan.

The techniques described herein can maximize computing power by crowdsourcing programming solutions from multiple users without disclosing confidential information regarding the robotic operating environment, resulting in increased volume and sophistication of robotic operating environment optimization solutions. For example, the system can genericize and anonymize the particular task or type of robot in the robotic operating environment to be optimized, which allows for maintained confidentiality of the process being performed by the robots. As a result, solutions for optimizing the task can be obtained from a much larger population of developers than would normally be exposed to the inner workings of the robotic operating environment, while maintaining secrecy of the specific tasks being performed by the robots. In addition, by crowdsourcing robotic operating environment optimization code, unlimited combinations and types of software, algorithms, simulation engines, and automation approaches can be implemented by the crowdsourced programmers to reach the optimal solution. As such, an operator or owner of a robotic operating environment is not limited to relying on programming code provided by a specialized, on-site systems integrator.

The system can provide an online (e.g., a cloud based) system for performing iterative testing to optimize and validate a particular robotic control plan for the robotic operating environment. For example, by providing an online simulated robotic operating environment, proposed robotic control plans for the robotic operating environment can be iteratively tested without resulting in any downtime of the “live” robotic operating environment. As a result, the downtime required to optimize robot tasks within a robotic operating environment is greatly reduced.

The details of one or more embodiments of the disclosure are set forth in the accompanying drawings and the description below. Other features, objects, and advantages will be apparent from the description and drawings, and from the claims.

### DESCRIPTION OF DRAWINGS

FIG. 1 is a diagram of an example system for obtaining, validating, and implementing optimized robotic control plans.

FIG. 2 is a flowchart of an example process for obtaining, validating, and implementing a candidate robotic control plan.

FIGS. 3-7 depict example user interfaces for generating an optimization challenge for a robotic operating environment.

Like reference numbers and designations in the various drawings indicate like elements.

### DETAILED DESCRIPTION

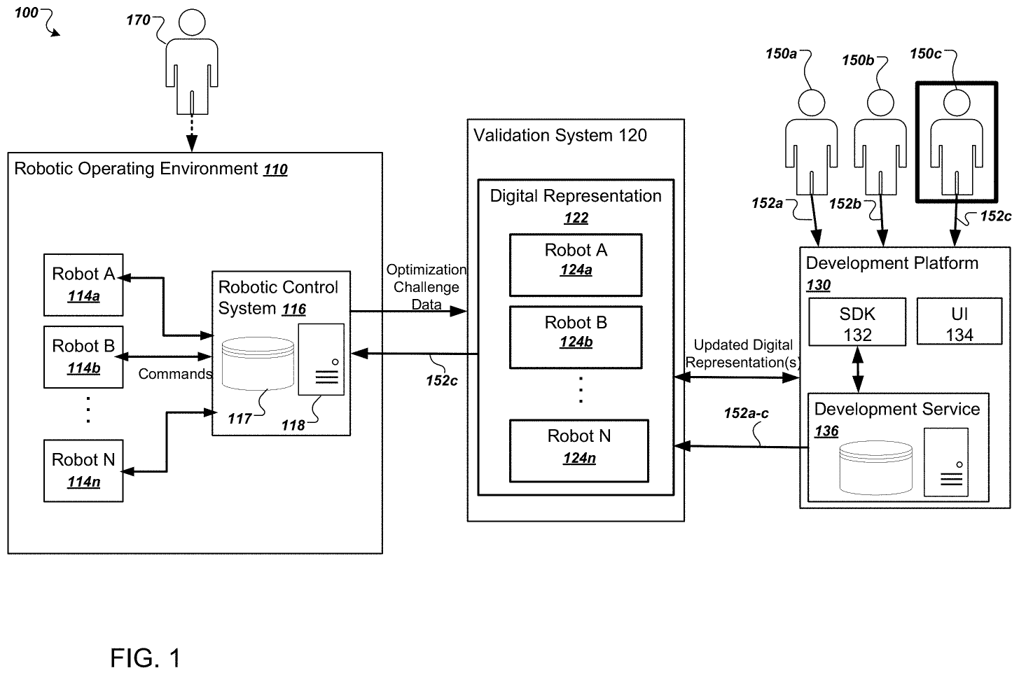

FIG. 1 is a diagram that illustrates an example system 100 for implementing decentralized optimization of robotic control plans. The system 100 is an example of a system that can implement the techniques described in this specification.

The system 100 includes a robotic operating environment 110, a validation system 120, and a development platform 130. Each of these components can be implemented as computer programs installed on one or more computers in one or more locations that are coupled to each other through any appropriate communications network, e.g., an intranet or the Internet, or combination of networks.

The robotic operating environment 110 includes one or more robots 114a-n and a robotic control system 116. In some implementations, the robots 114a-n are contained within a particular workcell within the robotic operating environment 110.

The robotic control system 116 is configured to control the robotic components 114a-n. For example, the robotic control system 116 can receive a robotic control plan and can execute the robotic control plan by issuing commands 118 to the robots 114a-n in order to drive the movements of the robots 114a-n. In some implementations, the robotic operating environment 110 is a robotic operating environment of original equipment manufacturer and robotic control system 116 is a manufacturing execution system that serves as an integration system for integrating data, processes and relevant machinery necessary for operation of the robotic operating environment 110.

As depicted in FIG. 1, the robotic control system 116 includes a data storage device 117 and a server device 118. The data storage device 117 can be used to store robotic control plans and other programming code required for operating the robotic operating environment 110. The server device 118 can be used to communicate with the validation system 120 to receive optimized robotic control plans that have been validated by the validation system 120.

The system 100 also includes a validation system 120. The validation system 120 is configured to distribute submitted challenges to one or more development platforms and to validate one or more optimized robotic control plans 152a-c received by the validation system 120 from by one or more respective developers 150a-c (e.g., using development platform 130). The validation system 120 includes a digital representation 122 of the robotic operating environment 110. Typically, the development platform 130 is operated by an entity that is unaffiliated with the validation system 120. In other words, the development platform 130 need not be controlled by an entity that operates the validation system 120 or the operating environment 110. Rather, to achieve the goal of truly decentralized robotic control planning, the development platform 130 can be any appropriate computing system in one or more locations regardless of its relationship to the validation system 120.

The digital representation 122 represents the robotic operating environment 110 to be optimized by the system 100. In general, the digital representation 122 can be used to test and validate robotic control plans 152a-c for the robotic operating environment 110 received by the system 100 (e.g., through the development platform 130). The digital representation 122 can be generated based on a preexisting digital model of the robotic operating environment 110 (“digital twin”) that is stored on the robotic control system 116 and uploaded to the validation system 120 by an operator 170 of the robotic operating environment 110. The digital representation 122 can be created based on information regarding the robotic operating environment 110 provided to the validation system 120. For example, parameters regarding the components of the robotic operating environment 110 and hardware in the robotic operating environment 110 (e.g., the robots 114a-n) can be submitted to the validation system by operator(s) 170 of the robotic operating environment 110, and based on the parameters regarding the robotic operating environment 110, the validation system 120 can generate a digital representation 122 that is an accurate digital representation of the robotic operating environment 110.

The validation system 120 can determine elements of the operating environment 110 to be represented in the digital representation. For example, based on data defining the target improvement, the validation system 120 can determine the relevant hardware, processes, and components of the robotic operating environment 110 necessary to be represented in the digital representation 122 of the robotic operating environment 110 in order for the digital representation 122 to execute the robotic task defined in the optimization challenge, and therefore necessary to be provided to developers 150 through the development platform 130. For example, the validation system 120 can determine robotic processes, such robotic movements (e.g., process to move a robot from position A to position B, and pick up object 1), and/or perception tasks, such as capturing an image with a robot-mounted camera that can be used for quality assurance, that need to represented to the developers 150 through the digital representation to accurately depict the task defined in the optimization challenge.

Developers 150a-c can use the development platform 130 to modify components (such as robots, hardware fixtures) and processes (such as robot movements) to meet the target improvement. The development platform 130 can transmit the improved components and processes 152a-c back to validation system 120, which executes the robotic tasks submitted by developers 150 and measures the improvement over the corresponding performance metrics related to the robotic tasks from robotic operating environment 110.

The digital representation 122 can also be used to mask components of the robotic operating environment 110. For example, an operator 170 can identify one or more components in the robotic operating environment 110 that should be masked and should not be included in the digital representation 122 of the robotic operating environment 110. Data identifying the components of the robotic operating environment 110 to be masked in the digital representation 122 can be provided as part of the optimization challenge submitted by the operator 170.

The validation system 120 can also be used to determine components of the robotic operating environment 110 that are not relevant to the task being optimized and exclude these components from the digital representation 122 of the robotic operating environment 110. For example, these components can be masked in order to protect proprietary information related to the robotic operating environment 110. For example, in submitting an optimization challenge to the validation system 120, operator(s) 170 can provide data defining a target improvement for a particular robotic task performed by one or more robots 114a-n in the robotic operating environment 110.

For example, if the task to be improved by the optimization challenge is a weld task performed by one or more of the robots 114a-n in the robotic operating environment 110, the details regarding the objects being welded (such as, the form factor of particular car components) can be masked in the digital representation 122 in order to protect proprietary details regarding the components being assembled in the robotic operating environment 110, while still allowing for accurate testing of robotic control plans provided to optimize the welding task. In addition, other objects or components in the robotic operating environment 110 that are not related to the particular task being optimized or that are not within the potential path of the robot(s) 114a-n performing the task can be excluded from the digital 122 representation of the robotic operating environment 110.

As will be discussed in further detail herein, parameters regarding the components of the robotic operating environment 110 and the data defining a target improvement to a robotic process involving one or more robots of the robotic operating environment 110 can be provided to the validation system 120 using one of several methods. For example, an operator 170 of the robotic operating environment 110 (e.g., a systems integrator) can manually enter the parameters defining the robotic operating environment 110 and the current operating metrics for the robotic task to be optimized using a user interface of the validation system 120. In some implementations, an operator 170 can import a previously generated digital model of the robotic operating environment 110 (“digital twin”) into the validation system 120, which can be used to generate the digital representation 122 of the robotic operating environment, and can then manually enter (e.g., into an online user interface) parameters related to the robotic task performed by the robotic operating environment 110 to be optimized.

In some implementations, the validation system 120 can also directly access the robotic control system 116 to obtain data defining the robotic operating environment 110 and data defining a target improvement for a robot task performed by the robots 110a-n of the robotic operating environment 110. For example, the validation system 120 can gather information related to the robotic operating environment 110 from one or more IT systems of the robotic operating environment 110 (e.g., robotic control system 116), and can automatically determine parameters related to the robotic operating environment 110 and potential robotic tasks to be optimized. For example, the IT systems for the robotic operating environment 110 (e.g., Product Lifecycle Management (PLM) systems, Programmable Logic Controllers (PLC) systems, and Manufacturing Execution systems (MES)) can be accessed by the validation system 120 to automatically identify information relevant for one or more optimization challenges for the robotic operating environment 110 (such as preexisting digital models of the robotic operating environment 110 and data related to robotic tasks performed by one or more robots 114 of the robotic operating environment 110).

As will be described in further detail herein, the digital representation 122 of the robotic operating environment 110 to be optimized can be made available to one or more developers 150a-c and the developers 150a-c can use the digital representation 122 to test robotic control plans 152a-c designed for optimizing the particular task described in the optimization challenge submitted to the validation system 120. For example, as depicted in FIG. 1, the system 100 includes a development platform 130 that can be accessed by developers 150a-c to view optimization challenges submitted to the validation system 120 and to test robotic control plans 152a-c aimed at optimizing a robotic task presented in a particular optimization challenge.

As can be seen in FIG. 1, the validation system 120 serves as an intermediary between the robotic operating environment 110 and the development platform 130. As a result, the validation system 120 serves to protect proprietary information of the robotic operating environment 110 by restricting access to information regarding the robotic operating environment 110 while also allowing for decentralized optimization of the robotic operating environment 110 by multiple developers 150a-c.

The development platform 130 can use a software development kit 132 (“SDK”). For example, the SDK 132 can be distributed by the validation system 120 for use by one or more development platforms 130. The SDK 132 can be a software subsystem that is compatible with the digital representations generated by the validation system 120. The SDK 132 can also have the ability to receive as input a particular task to be optimized as defined in an optimization challenge received from the validation system 120. As depicted in FIG. 1, in some implementations, the development platform 130 includes a development service 136 that can provide various tools to the developers 150a-c. For example, the development service 136 can provide an SDK 132 to the developers 150a-c that includes one or more of simulation services, motion planning services, and skills-based services that can be used by the developers 150a-c in developing candidate robotic control plans for the robotic operating environment 110. For example, the SDK 132 can include one or more of: design files for each robot 150a-n (e.g., CAD files), technical specifications for each robot 160a-n (e.g., payload capacity, reach, speed, accuracy thresholds, etc.), robot control simulation (RCS) data (e.g., modeled robot motion trajectories). In some implementations, the development service 136 can determine one or more possible methods for optimizing the task described in the optimization challenge, and can provide the suggested optimization methods to the developers 150a-c through the SDK 132. The SDK 132 can also provide developers 150a-c with particular placements of robots and hardware fixtures within the robotic operating environment, deep learning models (for example, models for object detection and form prediction), proprietary robotic skills (such as skills for dexterous manipulation using force torque sensors), physics, simulation engines that mimic real world physics, and/or computational services (for example, cloud based compute services).

As depicted in FIG. 1, the development platform 130 also includes a user interface 134 that can be used by the developers 150a-c to access development tools and a digital representation of the robotic operating environment 110 provided in the SDK 132 for generating and testing robotic control plans for optimizing the robotic task conducted by the robots 114a-n of the robotic operating environment 110 as defined in the optimization challenge. In some implementations, the user interface 134 provides the digital representation 122 to developers 150a-c using a CAD file or STL file.

The development platform 130 can include web-based, software as a service (SaaS) tools that simulate the robotic operating environment 110 and are programmable through interactive means, such as notebook programming products (for example, Jupyter notebooks). The development platform 130 can also include simulation engines that provides real time visualizations of the robotic operating environment 110. In some implementations, the development platform 130 provides developers 150a-c with augmented reality and/or virtual reality animation files generated based on the digital representation 122 of the robotic operating environment. These augmented reality and virtual reality files can be used to observe the robotic operating environment 110 simulated through the digital representation 122.

Developers 150a-c can submit candidate robotic control plans 152a-c for the optimization challenge to the system 100 using the user interface 134 of the development platform 130. As will be described in further detail herein, the candidate robotic control plans 152a-c generated by the developers 150a-c can be transmitted from the development platform 130 to the validation environment 120 and validated using the digital representation 122. For example, the digital representation 122 can execute each of the candidate robotic control plans 152a-c to determine whether one or more of the candidate robotic control plans 152a-c satisfies the target improvement defined in the optimization challenge based on the performance of the robots 124a-124n in the digital representation 122 executing the respective candidate robotic control plan 152a-c.

The software development kit 132 for developing and testing proposed robotic control plans can alternatively be distributed to developers 150a-c by the validation platform 120 directly. Further, the digital representation of the robotic operating environment 110 provided in the software development kit 132 can be very similar, if not identical, to the digital representation 122 of the validation system 120. If the software development kit 132 is provided to the developers 150a-c directly from the validation system 120 (rather than through a development platform 130), the proposed control plans 152a-c generated by the developers 150a-c can be submitted directly to the validation system 120 for validation and testing.

In addition, based on the data provided in the optimization challenge, the validation system 120 can generate a preliminary robotic control plan that can provided to the developers 150a-c (e.g., via development platform 130) as a template or starting point for generating candidate robotic control plans 152a-c. For example, based on the optimization challenge, the validation system 120 can generate a robotic control plan that is 80% optimized based on the target improvement defined in the optimization challenge. The developers 150a-c can then use the template robotic control plan generated by the validation system 120 as a template for generating a candidate robotic control plan that more closely satisfies the target improvement defined in the optimization challenge (e.g., a control plan that provides 100% or nearly 100% of the target improvement).

Upon validating that a particular candidate robotic control plan 152c satisfies the desired operating metrics defined in the optimization challenge, the validation system 120 can automatically transfer the validated robotic control plan 152c to the robotic operating environment 110 for execution by the robotic operating environment 110 in real time. For example, the validation system 120 can transfer the validated robotic control plan 152c to the robotic control system 116 of the robotic operating environment 110 in real time, and the robotic control system 116 can control the robots 114a-n in the robotic operating environment 110 to execute the validated, optimized robotic control plan 152c. In some implementations, the robotic control system 116 stores the validated robotic control plan 152c on an edge device (e.g., data storage device 117), and commands the robots 114a-n to execute the validated robotic control plan 152c at the appropriate time within the workflow of the robotic operating environment 110. As a result, the optimized robotic control plan 152c can be implemented within the robotic operating environment 110 without any downtime or interference with the current operations of the robotic operating environment 110.

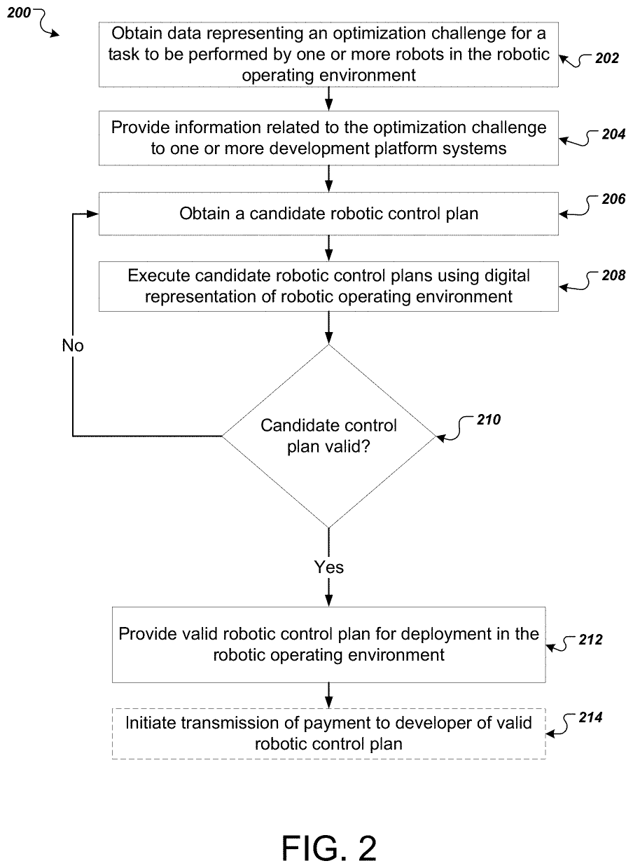

FIG. 2 depicts a flowchart of an example process 200 for obtaining, testing, and implementing candidate robotic control plans for a robotic operating environment using decentralized optimization. The process 200 can be performed by a computer system having one or more computers in one or more locations, e.g., the system 100 of FIG. 1. The process 200 will be described as being performed by a system of one or more computers.

The system obtains data representing an optimization challenge for a task to be performed by one or more robots in the robotic operating environment (202). The optimization challenge obtained by the system includes one or more associated goal criteria for the task to be performed by the one or more robots in the robotic operating environment to be optimized. In addition, the optimization challenge is associated with a digital representation of the robotic operating environment, such as digital representation 122 in FIG. 1.

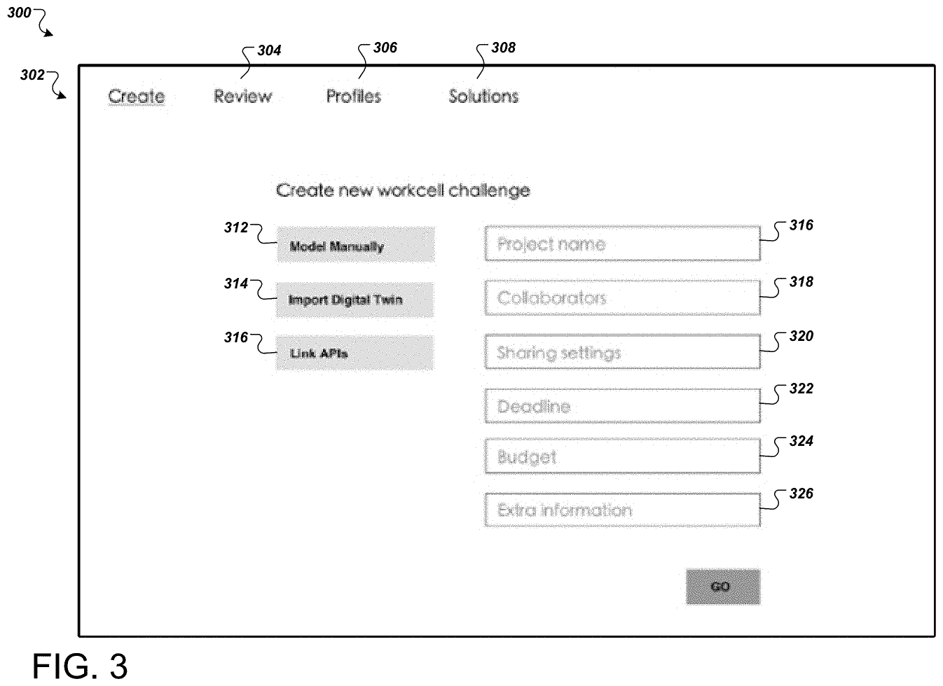

As previously discussed, the system can obtain data representing an optimization challenge using a variety of techniques. For example, FIG. 3 depicts an example user interface 300 that can be used by an operator of a robotic operating environment, such as a system integrator, to create and submit data for an optimization challenge for the robotic operating environment (e.g., robotic operating environment 110). The user interface 300 includes navigation tabs to navigate between various pages 302, 304, 306, 308 of the user interface 300. For example, the user interface 300 can include a “Create” page 302 for generating a new optimization challenge, a “Review” page 304 that can be used to review previously generated optimization challenges, a “Profiles” page 306 to view profiles created by the operator of the robotic operating environment, and a “Solutions” page 308 that can be used to access candidate robotic control plans obtained through distributed optimization in response to previously-generated optimization challenges.

FIG. 3 depicts the user interface 300 displaying the “Create” page 302 of the user interface 300. An operator can use the “Create” page 302 to create a new optimization challenge that can be used to solicit candidate robotic control plans for the robotic operating environment through distributed optimization. As can be seen in FIG. 3, the “Create” page 302 includes buttons 312, 314, 316 that can be used to select a particular data input method for collecting information about the robotic operating environment. For example, the “Create” page 302 includes a “Model Manually” button 312, an “Import Digital Twin” button 314, and a “Link APIs” button 316.

The “Create” page 302 of the user interface 300 also includes entry fields 318, 320, 322, 324, 326 that can be used to manually enter additional information about the optimization challenge. For example, the “Create” page 302 includes a “Project name” entry field 318 for entry of an operator-defined name for the optimization challenge. “Create” page 302 also includes a “Collaborators” entry field 318 for entry of one or more collaborators involved in the optimization challenge. “Create” page 302 includes a “Share settings” entry field 320 for defining settings related to how the challenge is shared on the development platform. A deadline and a budget for the optimization challenge can also be specified using entry fields 322 and 324, respectively. In some implementations, the “Create” page 302 includes an additional entry field 326 that allows a user to manually input any additional information that should be provided to the developers participating in the optimization challenge and that may be useful in generating and executing the optimization challenge.

“Create” page 302 can also be used to collect information regarding the target improvement and operating metrics for the optimization challenge. For example, a user 170 can provide parameters defining a particular task to be performed by the robotic operating environment and a threshold operating metric for the task (e.g., a maximum cycle time for performing the task). In some implementations, a user 170 can specify a current operating metrics for the robotic operating environment performing the task (e.g., a current cycle time for performing the task) and request robotic control plans that provide a target improvement over the current operating metric (e.g., control plans that provide a shorter cycle time than the current cycle time for performing the task). In some implementations, a user can specify a reward amount for each incremental improvement over the current operating metrics (e.g., $1000 per second of reduction in the current cycle time). In some implementations, the “Create” page 302 includes a menu (e.g., a drop down menu, not shown) listing various operating metrics that a user can select as the metric to be improved through the optimization challenge (e.g., speed, energy use, space requirements, longevity, etc.).

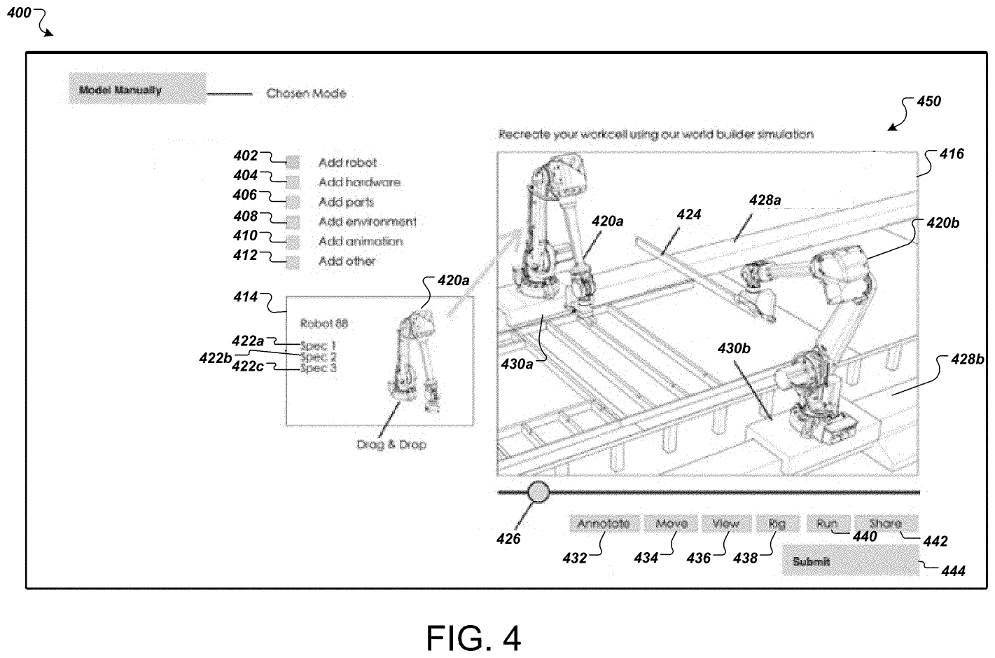

As depicted in FIG. 4, in response to selection of the “Model Manually” option 312 provided on the “Create” page 302 of the user interface 300, a manual modeling interface 400 is provided for the user to manually enter parameters regarding the robotic operating environment that is the subject of the optimization challenge. The manual modeling interface 400 includes several preset features 402-410 for adding various components to a digital representation 450 of the robotic operating environment in order to mimic the components of the robotic operating environment being optimized (e.g., robotic operating environment 110).

For example, the manual modeling interface 400 includes an “Add robot” feature 402 that can be used to add robot(s) 420a, 420b to the digital representation 450 of the robotic operating environment. The manual modeling interface 400 also includes an “Add hardware” feature 404 that can be used to add various hardware components (e.g., a base 430a, 430b attached to each of the robots 420a, 420b) to the digital representation 450 of the robotic operating environment. The manual modeling interface 400 can also include an “Add parts” feature 406 that can be selected to add one or more parts (e.g., part 424) that are being operated on by the robots in the robotic operating environment to the digital representation 450 of the robotic operating environment. The manual modeling interface 400 can also include an “Add environment” feature 408 which can be used to add component(s) of the robotic operating environment itself (e.g., rails 428a, 428b along which the robots 420a, 420b of the robotic operating environment travel) to the digital representation 450 of the robotic operating environment.

The manual modeling interface 400 can also include an “Add animation” feature 410 that can be used to animate one or more components of the digital representation 450 of the robotic operating environment in order to mimic the motion of the corresponding components within the robotic operating environment during performance of a particular task. For example, the “Add animation” feature 410 can be used to specify the timing of each of the robots in the robotic operating environment 110, such that the robots in the digital representation 450 of the robotic operating environment 110 will follow the same path as the robots 114a-n in the robotic operating environment 110. In some implementations, the “Add animation” feature 410 can be used to specify a series of waypoints that must be touched by the end effector of a robot 420a in order for the robot 420a to perform a particular task. In some implementations, once the “Add animation” feature 410 is selected, a user can drag and manipulate components of the digital representation 450 in order to represent movement of the corresponding components in the robotic operating environment 110 during the task that is defined in the optimization challenge. In some implementations, in response to moving a component of the digital representation, the user is provided with one or more numerical fields indicating the spatial coordinates and timing associated with the movement of the component within the digital representation 450 provided by the user. If needed, the user can then adjust the coordinates and/or timing to fine tune the movement of the component.

In addition to preset features 402-410, the manual modeling interface 400 can also include an “Add other” feature 412, which can be used to add a custom feature to the digital representation 450 of the robotic operating environment. In response to selecting the “Add other” feature 412, a user can be presented with an interface to specify the dimensions, motions, and other parameters of a custom component to be added to the digital representation 450 of the robotic operating environment. In some implementations, in response to selecting the “Add other” feature 412, the manual modeling interface 400 provides the user with a three-dimensional modeling tool for creating a three-dimensional model of the custom component to be added to the digital representation 450 of the robotic operating environment. In some implementations, in response to selecting the “Add other” feature 412, the manual modeling interface 400 presents the user with a file explorer that can be used to identify and select an existing model of a component (e.g., CAD file) that can be imported into the digital representation 450. The “Add other” feature 412 can be used to add custom end of arm tools (EOAT) that have their own geometry to a robot in the digital representation 450, such as a custom gripper or weld gun positioned at the end of the robot to perform a task. The “Add other” feature 412 can also be used to add visual markers to the digital representation 450 that serve as waypoints to be passed through by the robots in the digital representation 450 of the robotic operating environment when performing the task defined by the optimization challenge in order aid in visualization.

The manual modeling interface 400 can provide a preview of a selected component prior to adding the component to the digital representation 450 of the robotic operating environment. For example, the manual modeling interface 400 can include a preview pane 414 that depicts a preview of a component to be added to the digital representation 450 of the robotic operating environment together with specifications for the component. For example, as depicted in FIG. 4, in response to selection of the “Add robot” feature 402, the preview pane 414 displays the robot 420a to be added to the digital representation 450 of the robotic operating environment. The preview pane 414 also displays one or more specifications 422a-c and technical details regarding the robot 420a. As such, the user can review details regarding the component (e.g., robot 420a) before adding the component to the digital representation 450 of the robotic operating environment.

In response to the selection of a robotic operating environment component or animation using features 402-412, the selected component or animation can be added to the digital representation 450 of the robotic operating environment. For example, in response to selection of the “Add robot” feature 402, a robot 420 is displayed in the preview pane 414 and the user 170 can add the displayed robot 420 to the digital representation 450 by dragging and dropping the robot 420 from the preview pane 414 to a visualization pane 416 displaying the digital representation 450 of the robotic operating environment.

A visualization pane 416 of the manual modeling interface provides a visual representation of the digital representation 450 of the robotic operating environment, and can be used to test operations performed by the robots 420a, 420b added to the digital representation 450 of the robotic operating environment. For example, the digital representation 450 of the robotic operating environment can be programmed (e.g., using the “Add animation” feature 410) to cause the robots 420a, 420b to perform one or more tasks defined in the optimization challenge. A playback button 426 can be used to preview the motion of the robots 420a, 420b within the digital representation 450 as they perform the designated task(s).

For example, the robots 420a, 420b may be slidably mounted on a fixed beam 428a, 428b in the digital representation 450 of the robotic operating environment 110 via corresponding hardware components 430a, 430b and, as part of the task defined in the optimization challenge, the robots 420a, 420b slide along the fixed beam 428. By sliding the playback button 426 left and right, the motions of the robots 420a, 420b as they slide along the fixed beams 428a, 428b to perform the task can be previewed in the visualization pane 416. By previewing the motions of the robots 420a, 420b in the digital representation 450 using the playback button 426, the user can confirm that the motions of the robots 420a, 420b in the digital representation 450 match the motions of the robots 114a-n in the corresponding robotic operating environment 110, and can identify any errors in animation or additional animations that need to be added to the components of the digital representation 450 to accurately reflect the current operations of the robotic operating environment 110.

Manual modeling interface 400 can also include an annotation feature 432 that can be used to annotate one or more components within the digital representation 450 of the robotic operating environment. For example, the user can use the annotation feature 432 to add comments regarding one or more components within the digital representation 450 that can be viewed by developers (e.g., developers 150a-c) testing candidate robotic control plans using the digital representation 450 (e.g., on the development platform 130 of FIG. 1), for example to provide guidance to the developers 150a-c. For example, the annotation feature 432 can be used insert comments to the developers 150a-c regarding previous attempts at optimizing the robotic operating environment that did not work (e.g., a comment stating “moving robot 114a left to right instead of right to left to perform the task did not yield significant improvement”). As another example, the annotation features 432 can be used by the user to include comments in the digital representation 450 that include hints or suggestions to the developers 150a-c at possible strategies for improvements (e.g., a comment stating “moving robot 114s to the left could likely improve performance”).

Manual modeling interface 400 also includes a move feature 434 that can be used to move one or more components of the digital representation 450 of the robotic operating environment from a first location within the digital representation 450 to a different location within the digital representation 450. For example, upon selecting the move feature 434, the user 170 can move one or more of the robots 420a, 420b, part 424, fixed beams 428a, 428b and/or hardware 430a, 430b by selecting the desired component and dragging and dropping the component at a new location within the digital representation 450 of the robotic operating environment. For example, the move feature 434 can be used to move a robot to a location within the digital representation 450 of the robotic operating environment that improves reachability of two waypoints in sequence, for example, by positioning the robot from an original location to a new location such that the robot is faster than when traveling between the two waypoints when positioned in the new location compared to when the robot was positioned in the original location. In some implementations, if the move feature 434 is not selected, the position of the components within the digital representation 450 is fixed and cannot be moved.

Manual modeling interface 400 can also include a view feature 436 that can be used to preview the process performed in the robotic operating environment as presented to the to developers 150a-c in the optimization challenge.

Manual modeling interface 400 can also include a rig feature 438 that can be used to couple two separate components within the digital representation 450 such that the components will move together within the digital representation 450 as a single object. For example, the rig feature 438 can be selected to “rig” a rail 428a to a robot 420a such that their two separate CAD shapes join and act as one alpha shape. As a result, after rigging the rail 428a to the robot 420a, the robot 420a that can move (e.g., slide) along a rail, because the geometries of the robot 420a and the rail 428a are joined and not separate.

Manual modeling interface 400 includes a run feature 440 that can be used to preview the entire sequence of animations programmed for the digital representation 450 of the robotic operating environment. For example, after defining a series of waypoints for the end effector of each robot 420a, 420b in the digital representation 450 to perform a particular task defined in the optimization challenge, the run feature 440 can be selected and the visualization pane 416 will display the movement of the robots 420a, 420b within the digital representation 450 according to the selected waypoints and timing sequence.

Manual modeling interface 400 can also include a share feature 442 that can be used to share the digital representation 450 of the robotic operating environment with one or more other users. For example, an operator 170 of the robotic operating environment 110 can generate a digital representation 450 of the robotic operating environment 110 using the manual modeling interface 400 and can use the share feature 442 to share and provide access to the digital representation 450 to other operators of the robotic operating environment 110. For example, the share feature 442 can be used to facilitate collaborative editing of the digital representation 450 by multiple users. As another example, a first user can generate the digital representation 450 and can use the share feature 442 to invite a second user to review the digital representation 450 for accuracy.

Once the digital representation 450 of the robotic operating environment has been generated and the task to be improved has been fully defined, the submit button 444 may be used to submit the digital representation 450 and the optimization challenge for distributed optimization via solicitation of candidate robotic control plans. For example, once the digital representation 450 of the robotic operating environment has been fully defined, a user 170 can select the submit button 444 to transmit the optimization challenge together with the digital representation 450 of the robotic operating environment to a development platform (e.g., development platform 130 of FIG. 1), and developers can access the optimization challenge and digital representation 450 through the development platform 130 and submit candidate robotic control plans for the optimization challenge to the development platform 130.

In addition to generating a digital representation of the robotic operating environment by manually modeling the robotic operating environment, a user can upload a previously-generated model of the robotic operating environment 110 (a “digital twin” of the robotic operating environment) that can be used as the basis for generating a digital representation of the robotic operating environment for the optimization challenge. For example, referring back to FIG. 3, the “Create” page 302 includes an “Import Digital Twin” button 314 that can be used to upload a previously-generated digital model of the robotic operating environment defined in the optimization challenge. For example, an operator 170 of a robotic operating environment 110 can submit an optimization challenge for a task performed by one or more robots 114a-n of the robotic operating environment 110 by inputting details and operating metrics regarding the task and selecting the “Import Digital Twin” button 314 to upload a previously-generated digital model of the robotic operating environment 110.

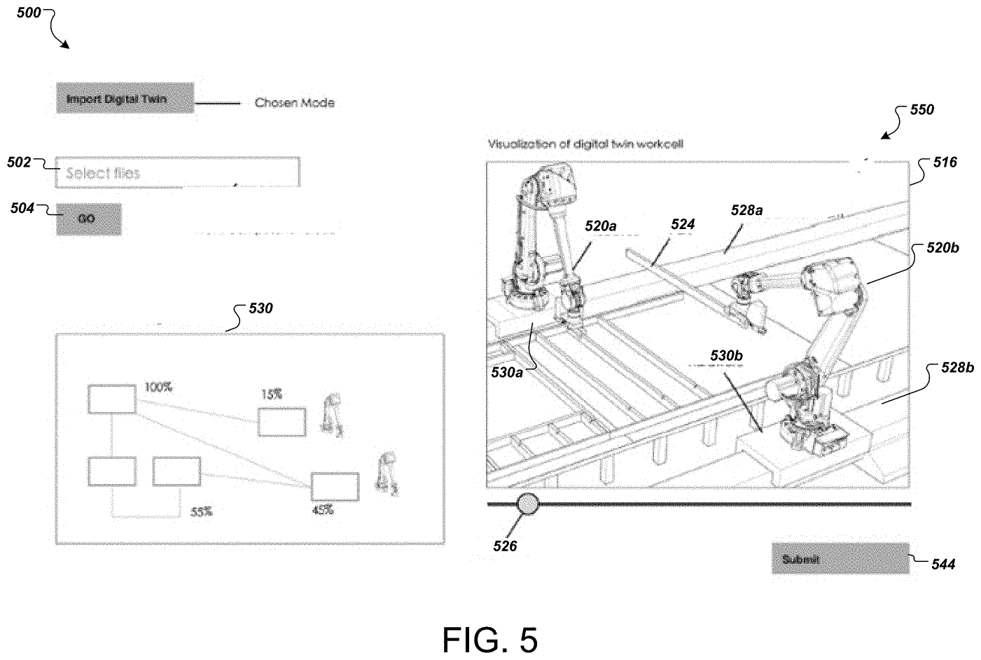

Referring to FIG. 5, in response to selecting the “Import Digital Twin” button 314, an uploading interface 500 is presented to the user 170 to upload a previously-generated digital model of the robotic operating environment 110 to the validation system 120 that can be used as a basis for the digital representation for the optimization challenge. As can be seen in FIG. 5, uploading interface 500 includes a file selection field 502 that can be used to browse for local or cloud-based files of previously-generated digital models of the robotic operating environment 110. Once the file(s) containing the previously-generated digital model of the robotic operating environment 110 have been located, button 504 can be used to upload the previously-generated digital model to the validation system 120.

Once the files for the previously-generated model of the robotic operating environment 110 have been selected, the validation system 120 can use the previously-generated model to generate a digital representation 550 of the robotic operating environment 110. For example, the validation system 120 can generate a three-dimensional digital representation 550 of robotic operating environment 110 in a graphical user interface visualization pane 516 based on the previously-generated model of the robotic operating environment 110. Similar to visualization pane 416 of the manual modeling interface 400, visualization pane 516 provides a preview of the digital representation 550 of the robotic operating environment that has been generated based on the previously-generated model of the robotic operating environment 110 uploaded from the robotic control system 116 using uploading interface 500.

The system can anonymize the previously-generated digital model of the robotic operating environment 110 uploaded by the user 170 as part of generating digital representation 550. For example, the previously-generated digital model of the robotic operating environment 110 may specify a particular brand or model of robots contained within the robotic operating environment 110. In order to anonymize the robotic operating environment 110, the validation system 120 can generate a digital representation 550 that removes any features from the robots 520a, 520b that may identify the particular brand or model of the robots 520a, 520b. Similarly, the previously-generated digital model uploaded using the uploading interface 500 may specify a particular type of part that is being operated on by the robots 114a-n in the robotic operating environment 110. In order to anonymize the robotic operating environment, the digital representation 550 generated based on the previously-generated digital model may simply represent a generic part as the item being operated on by the robots 520a, 520b without specifying the specific part type.

By anonymizing one or more components of the robotic operating environment 110 in the digital representation 550 of robotic operating environment 110, the digital representation 550 can be broadly disseminated to developers without risk of disclosure of confidential details of the robotic operating environment 110. As a result, distributed optimization for a task performed by the robotic operating environment 110 can be effectively accomplished without disclosure of confidential information.

In some implementations, the digital representation 550 of the robotic operating environment generated based on the previously-generated digital model of the robotic operating environment 110 can be adjusted using the visualization pane 516. For example, a user 170 can drag and drop one or more components in the digital representation 550 to adjust the position and/or movement of the respective component(s) within the digital representation 550.

The digital representation 550 generated based on the uploaded digital model can be used to model a task performed by the robots 114a-n in the robotic operating environment 110. For example, the robots 114a, 114b in the robotic operating environment 110 are represented by digital robots 520a, 520b in the digital representation 550 of the robotic operating environment (e.g., based on robots depicted in the previously-generated digital model of the robotic operating environment 110), and animation can be added to the digital robots 520a, 520b to cause the digital robots 520a, 520b to execute a particular task defined in the optimization challenge. Parameters for the particular task to be executed by the robots 520a, 520b in the digital representation 550 and optimized through the optimization challenge can be provided using the same or similar methods as those described in reference to FIG. 3.

A playback button 526 can be used to preview the motion of the robots 520a, 520b within the digital representation 550 as they perform the task defined in the optimization challenge. For example, the robots 520a, 520b may be slidably mounted on a fixed beam 528a, 528b in the robotic operating environment via corresponding hardware components 530a, 530b and, as part of the task performed by the robots 520a, 520b on part 524, the robots 520a, 520b slide along the respective fixed beams 528a, 528b. By sliding the playback button 526 left and right, the motions of the robots 520a, 520b as they slide along the fixed beams 528a, 528b to perform the task can be previewed in the visualization pane 516. By reviewing the motions of the robots 520a, 520b in the digital representation 550 using the playback button 526, a user can confirm whether the motions of the robots 520a, 520b in the digital representation 550 match the motions of the robots 114a, 114b in the corresponding robotic operating environment 110, and can identify any errors in animation or additional animations that need to be added to the components of the digital representation 550 to accurately reflect the operations of the robotic operating environment 110.

Uploading interface 500 can also include a summary of the process flow for the digital representation 550 of the robotic operating environment. For example, as depicted in FIG. 5, the uploading interface 500 can include a workflow summary pane 530 that provides an abstracted view of the information flow between the workcell hardware and systems. The view provided in summary pane 530 can be similar to the view of a robotic operating environment provided by a Manufacturing Execution System of the robotic operating environment, which is an IT system that triggers operations across a robotic operating environment, and thus provides a historical log of cycle times serving as operating metrics. This summary pane 530 highlights the backend processes that result in the visualization 550.

A user can also submit an optimization challenge for a robotic operating environment and generate a digital representation of the robotic operating environment by linking an information technology (IT) system of the robotic operating environment to be optimized to the validation system 120 such that validation system 120 can search the IT systems of the robotic operating environment for digital models of the robotic operating environment and potential optimization opportunities.

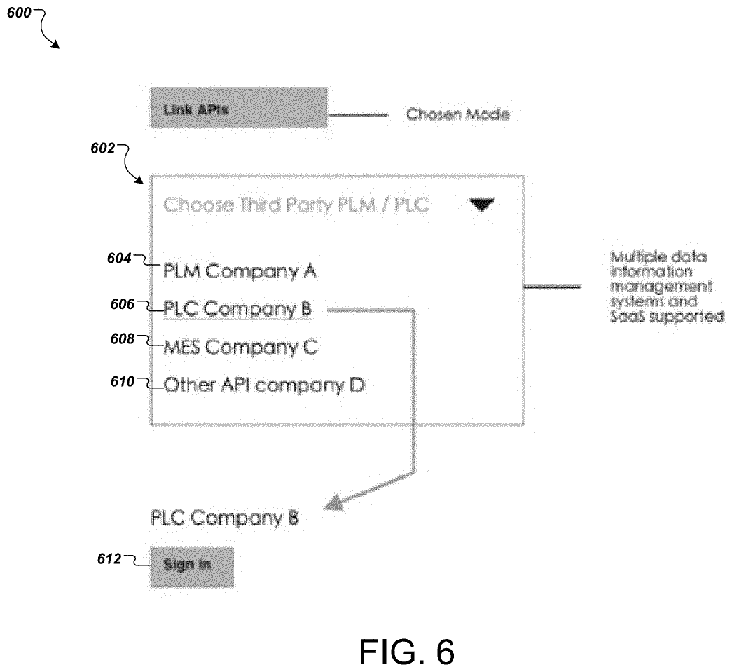

For example, referring to FIG. 3, the “Create” page 302 of the user interface 300 includes a “Link APIs” button 316 that can be selected to link an API of the validation system 120 to an IT system corresponding to the robotic operating environment to be optimized (e.g., the robotic control system 116 of robotic operating environment 110 in FIG. 1). Referring to FIGS. 1 and 6, in response to selection of the “Link APIs” button 316, the user is presented with a selection interface 600 that can be used to select one or more IT systems corresponding to the robotic operating environment 110 to be optimized. For example, as depicted in FIG. 6, the selection interface 600 includes a dropdown menu 602 listing several IT systems 604, 606, 608, 610 that can be linked to the validation system 120. Several types of IT systems can be linked to the validation system 120 for generating an optimization challenge and digital representation, including Product Lifecycle Management (PLM) systems, Programmable Logic Controller (PLC) systems, Manufacturing Execution systems (MES), offline planning systems (OLP), as well as other types of data management system and software as a service (SaaS) systems related to the robotic operating environment 110. For example, a Manufacturing Execution System is an IT component that triggers operations across workcells, and thus can provide a historical log of cycle times serving as operating metrics. As another example, offline planning systems (OLP) simulate entire robotic operating environments with highly accurate digital representations of hardware, robots and components of a robotic operating environment, similar to a detailed three dimensional high fidelity animation.

In some implementations, multiple IT systems of the robotic operating environment 110 can be linked to the validation system 120 in order to generate the optimization challenge and digital representation of the robotic operating environment. For example, a user 170 can select to link a PLM system, a PLC system, and an MES system of the robotic operating environment 110 to the validation system 120. Once linked, validation system 120 can then search the PLM system for digital models of the robotic operating environment 110, can search the PLC system for tasks performed by each of the robots 114a-n of the robotic operating environment 110 modeled in the PLM system, and can search the MES system for the sequence and timing of the each tasks described in the PLM system.

In order to improve security, in some implementations, the selection interface 600 requires the user to provide verification information for the selected IT system in order to connect the respective IT system to the validation system 120. For example, as depicted in FIG. 6, in response to selection of a particular IT system 608, the user 170 selects a “Sign In” button to provide log in and/or authentication information for the selected IT system 608. Once the appropriate credentials are provided for the selected IT system 608, the selected IT system 608 of the robotic operating environment 110 is linked to the validation system 120. As previously discussed, multiple IT systems 604, 606, 608, 610 can be selected using the selection interface 600 and linked to the validation system 120

Once one or more IT systems 604, 606, 608, 610 corresponding to the robotic operating environment 110 are linked to the validation system, the validation system 120 can search the linked IT system(s) to retrieve one or more digital models of the robotic operating environment 110 stored on the IT system(s), as well as identify corresponding tasks performed by the robot(s) 114a-n in the robotic operating environment 110 and the sequence and timing of each task performed by the robot(s) 114a-n in the robotic operating environment 110. Based on the retrieved models, identified tasks, and identified sequence/timing, the validation system 120 can present the user 170 with a list of potential tasks performed by one or more robot(s) 114a-n in the robotic operating environment 110 that are candidates for optimization. For example, the validation system 120 can compare the robotic operating environment models, tasks, and timing retrieved from the IT system(s) corresponding to the robotic operating environment 110 to previously-optimized robotic tasks in order to identify which of the tasks performed by the robot(s) 114a-n of the robotic operating environment 110 are most likely to be improved through a distributed optimization challenge. Each of the candidate optimization challenges identified by the validation system 120 can be presented to the user 170 (e.g., through a user interface), and the user 170 can select one or more of the candidate optimization challenges to be uploaded to the development platform 130 for distributed optimization through the solicitation of candidate robotic control plans.

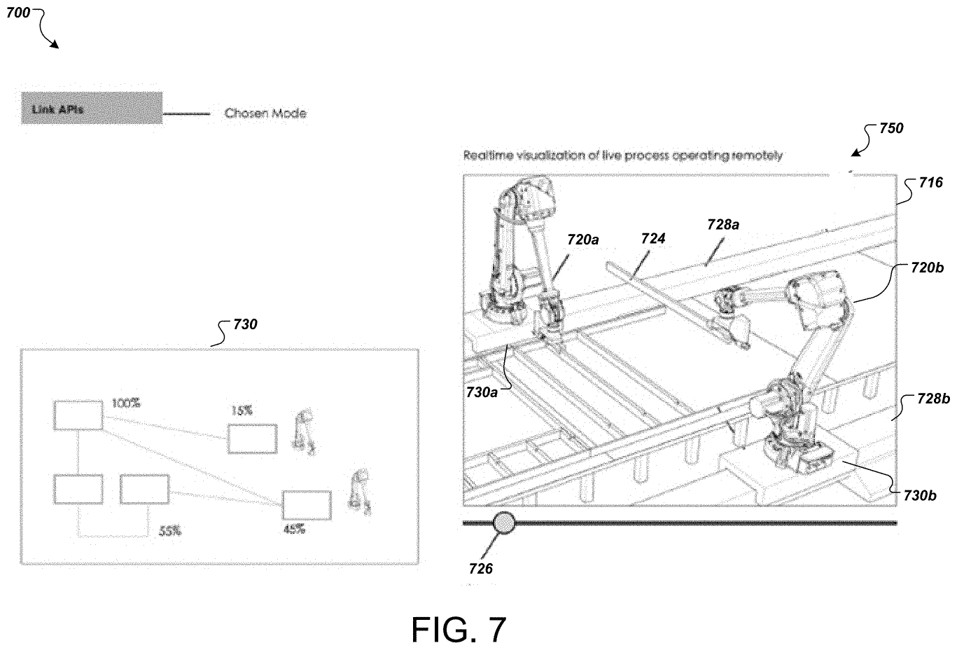

Referring to FIG. 7, in response to a user's selection of a particular optimization challenge that was identified by the validation system 120 (for example, by searching the IT systems of the robotic operating environment 110), the user 170 is presented with a user interface 700 displaying a digital representation 750 of the robotic operating environment 110 generated based on data from the IT systems of the robotic operating environment 110 and the identified task corresponding to the selected optimization challenge. For example, the validation system 120 can generate a three-dimensional digital representation 750 of robotic operating environment 110 based on a previously-generated model of the robotic operating environment 110 stored on an IT system of the robotic operating environment 110, and the digital representation of the robotic operating environment 110 can be presented to the user in a graphical user interface visualization pane 716. Similar to the visualization pane 516 of uploading interface 500, visualization pane 716 provides a visual representation of the digital representation 750 of the robotic operating environment 110 generated based data retrieved by the validation system 120 from one or more IT systems of the robotic operating environment 110 by linking the IT system(s) of the robotic operating system 110 to the validation system 120.

In generating the digital representation 750 of the robotic operating environment, the system can anonymize a previously-generated digital model of the robotic operating environment 110 retrieved by the validation system 120 from the IT systems 604-610. For example, a previously-generated digital model of the robotic operating environment 110 may specify a particular brand or model of robots within the robotic operating environment 110, and in order to anonymize the robotic operating environment 110, the validation system 120 can generate a digital representation 750 that removes any features from the robots 720a, 720b in the digital representations 750 that may identify the particular brand or model of the robots 720a, 720b. Similarly, the previously-generated digital model retrieved by the validation system from the IT systems 604-610 of the robotic operating environment 110 may specify a particular type of part being operated on by the robots 114a-n in the robotic operating environment 110. In order to anonymize the robotic operating environment 110, the digital representation 750 may simply represent a generic part as the item being operated on by the robots 720a, 720b, rather than specifying the specific type of part. By anonymizing one or more components within the robotic operating environment 110 in the digital representation 750, the digital representation 750 can be broadly disseminated to developers 150a-c without risking disclosure of confidential details of the robotic operating environment 110. As a result, distributed optimization for the robotic operating environment 110 can be effectively accomplished without disclosure of confidential information.

The digital representation 750 generated based on data retrieved by the validation system 120 from the IT systems 604-610 of the robotic operating environment 110 can be used to model a task performed by the robot(s) 114a-n in the robotic operating environment 110 corresponding to the selected optimization challenge. For example, the robots 114a, 114b in the robotic operating environment 110 are represented by digital robots 720a, 720b in the digital model 750 of the robotic operating environment 110, and the digital representation 750 is programmed by the validation system 120 to animate the robots 720a, 720b and cause the robots 720a, 720b to execute a particular task corresponding to the optimization challenge identified by the validation system 120 and selected by the user 170.

A playback button 726 can be used to preview the motion of the robots 720a, 720b within the digital representation 750 as they perform the task defined in the selected optimization challenge. For example, the robots 720a, 720b may be slidably mounted on a fixed beam 728a, 728b in the digital representation 750 of the robotic operating environment 110 via respective hardware components 730a, 730b and, as part of the task performed by the robots 720a, 720b on part 724, the robots 720a, 720b slide along the respective fixed beams 728a, 728b. By sliding the playback button 726 left and right, the visualization pane 716 of the digital representation 750 depicts the motions of the robots 720a, 720b as they slide along the fixed beams 728a, 728b to perform the task defined in the optimization challenge. By previewing the motions of the robots 720a, 720b in the digital representation 750 using the playback button 726, a user 170 can confirm whether the motions of the robots 720a, 720b in the digital representation 750 match the motions of the robots 114a, 114b in the corresponding robotic operating environment 110, and can identify any errors in animation or additional animations that need to be added to the components of the digital representation 750 to accurately reflect the operations of the robotic operating environment 110.

Uploading interface 700 can also include a summary of the process flow for the digital representation 750. For example, as depicted in FIG. 7, the uploading interface 700 can include a workflow summary pane 730 that provides an abstracted view of the information flow between the workcell hardware and systems. The view provided in summary pane 730 can be similar to the view of a robotic operating environment provided by a Manufacturing Execution System of the robotic operating environment, which is an IT system that triggers operations across a robotic operating environment, and thus provides a historical log of cycle times serving as operating metrics. This summary pane 730 highlights the backend processes that result in the visualization 750. Referring back to FIGS. 1 and 2, once the data regarding the robotic operating environment and the robotic task to be optimized are obtained and the digital representation is generated, the validation system 120 provides information related to the optimization challenge to one or more development platform systems (204). For example, once the data regarding the optimization challenge has been obtained by the validation system 120, the validation system 120 can transmit data identifying and describing the optimization challenge to one or more development platforms, such as development platform 130 of FIG. 1, and the development platforms can present the optimization challenge to developers 150a-c accessing the development platform 130. Typically, the development platform(s) 130 are operated by an entity that is unaffiliated with the validation system 120.

Once the validation system 120 has provided the identification of the optimization challenge to the development platform(s) 130, the validation system 120 can obtain one or more candidate robotic control plans submitted in response to the optimization challenge (206). For example, once the validation system 120 has provided the identification of the optimization challenge to the development platform(s) 130, developers 150a, 150b, 150c can access the optimization challenge through the development platform 130 and create and test candidate robotic control plans for the optimization challenge. For example, developers 150a, 150b can test candidate robotic control plans for the optimization challenge using a digital representation provided by the development platform 130, which may be the same as or similar to the digital representation 122 generated by the validation system 120 for the optimization challenge. Each of the candidate robotic control plans 152a-c generated by the respective developers 150a-c can be submitted for testing and verification using the development platform 130, and the development platform 130 transmits the candidate robotic control plans 152a-c to the validation system 120 for validation. In some implementations, developers 150a-c submit candidate robotic control plans 152a-c to the validation system 120 by uploading the code file for the candidate robotic control plan 152 through the SDK 132 of the development platform. In some implementations, developers 150a-c submit candidate robotic control plans 152a-c to the validation system 120 using a “submit solution” button in the UI 134 of the development platform 130.

Candidate control plans can continue to be obtained by the system until a deadline for the optimization challenge is reached. For example, as depicted in FIG. 3, the parameters received for the optimization challenge can include a deadline, and the development platform 130 can continue to solicit candidate robotic plans until the deadline for the optimization challenge is reached. In some implementations, once the deadline is reached, additional candidate control plans are no longer received by the development platform 130 for the optimization challenge, and each of the received candidate robotic control plans 150a-c is transmitted to the validation system 120 for validation and compared to determine the plan that most optimizes the operating metrics of the optimization challenge, as described in further detail herein.

Once the candidate robotic control plan(s) are obtained, the validation system 120 executes the candidate robotic control plan(s) using the digital representation 122 of the robotic operating environment 110 (208). Based on execution of each of the candidate robotic control plan(s) within the digital representation 122 of the robotic operating environment 110, the validation system 120 determines whether any of the candidate control plan(s) received by the validation system 120 is valid according to the target improvement defined in the optimization challenge (210).

For example, if user 170 defines an optimization challenge to reduce the cycle time for a task performed by the robots 114a-n in the robotic operating environment 110 and provides an operating metric in the optimization challenge defining the current cycle time for the task as five seconds, each of the candidate robotic control plans 152a, 152b, 152c received by the validation system 120 for the optimization challenge can be executed by the validation system 120 using the digital representation 122, and the cycle time for the task as performed by the robots 124a-124n of the digital representation 122 when executing each of the respective candidate robotic control plans 152a, 152b, 152c can be measured. Based on the cycle times measured through execution of each of the candidate robotic control plan 152a-c in the digital representation 122, it can be determined whether any of the candidate robotic control plans 152a-c optimizes the operating metric provided for the optimization challenge (i.e., whether any of the proposed robotic control plan 152a-c provides a cycle time less than the 5 second current cycle time defined in the optimization challenge). For example, if, based on execution of the proposed robotic control plans 152a-c in digital representation 122 of the robotic operating environment 110, it is determined that each of proposed robotic control plan 152a-152c provides the target improvement defined in the optimization challenge (e.g., a cycle time less than the current five seconds cycle time), each of the candidate robotic control plans 152a-152c is identified as valid.

If none of the received candidate control plans provide the target improvement, the validation system 120 can continue to solicit candidate robotic control plans from developers through the development platform(s) 130. For example, referring to the example above, a user 170 can submit an optimization challenge with a target improvement to reduce the cycle time for a task performed by the robots 114a-n in the robotic operating environment 110 and provide an operating metric defining the current cycle time for the task as five seconds. If based on executing of each of the obtained candidate robotic control plans 152a, 152b, 152c in digital representation 122, it is determined that none of the obtained proposed robotic control plan 152a-152bc provides a cycle time of less than five seconds, it is determined that none of the candidate robotic control plans 152a-152c is valid based on the optimization challenge and, as a result, the validation system 120 continues to solicit candidate robotic control plans from developers through the development platform(s) 130.

If the validation system 120 determines that multiple candidate robotic control plans optimize the operating metric, and thus are valid plans for the optimization challenge, the validation system 120 can further identify the candidate robotic control plan of the validated plans that best satisfies the target improvement defined in the optimization challenge. For example, referring to FIG. 1, after executing each of the candidate robotic control plans 152a-c within the digital representation 122 of the robotic operating environment 110, the validation system 120 can determine which of the candidate robotic control plans 152a-c best satisfies the target improvement defined in the optimization challenge.

For example, continuing the example above, based on the cycle times measured through execution of the candidate robotic control plan 152a-c in the digital representation 122 of the robotic operating environment 110, the validation system 120 can determine a robotic control plan of the validated candidate robotic control plans that most greatly reduces the cycle time for the task compared to the current cycle time provided in the optimization challenge. For example, if, based on execution of the proposed robotic control plans 152a-c in digital representation 122 of the robotic operating environment 110, it is determined that candidate robotic control plans 152a and 152b each reduce the cycle time for the particular task by one second and candidate robotic control plan 152c reduces the cycle time for the task by three seconds, robotic control plan 152c is identified and validated as the best optimized robotic control plan.

If only one of the obtained robotic control plans 152a-152c is validated as providing the target improvement defined in the optimization challenge, the single robotic control plan identified as optimizing the operating metric is identified as the best optimized robotic control plan. For example, if user 170 provides an optimization challenge to reduce the cycle time for a task performed by the robots 114a-n in the robotic operating environment 110 and provides an operating metric defining the current cycle time for the task as five seconds, and, based on execution of the proposed robotic control plans 152a-c in digital representation 122 of the robotic operating environment 110, it is determined that only robotic control plan 152c reduces has a cycle time less than 5 seconds (i.e., is the only robotic control plan that optimizes the operating metric), proposed robotic control plan 152c is identified as the only valid robotic control plan.

The system provides the validated candidate robotic control plan for deployment in the robotic operating environment (212). In some implementations, the robotic control plan 152c identified by the validation system 120 as the best optimized robotic control plan is transferred from the validation system 120 to an operator 170 of the robotic operating environment 110 for execution of the validated robotic control plan within the robotic operating environment 110 in real time. The validation system 120 can transfer a validated robotic control plan 152c to the robotic control system 116 of the robotic operating environment 110 in real time. Upon receiving the validated robotic control plan 152c, the robotic control system 116 can control the robots 114a-n in the robotic operating environment 110 to execute the validated, optimized robotic control plan 152c.

In some implementations, the robotic control system 116 stores the validated robotic control plan 152c on an edge device (e.g., data storage device 117), and commands the robots 114a-n to execute the validated robotic control plan 152c at the appropriate time within the workflow of the robotic operating environment 110. As a result, the validated robotic control plan 152c can be implemented within the robotic operating environment 110 without any downtime or interference with the current operations of the robotic operating environment 110.

The system can optionally initiate the transmission of a payment to the developer that provided the valid robotic control plan that is deployed in the robotic operating environment (214). For example, operator 170 of the robotic operating environment 110 can specify in the optimization challenge that each one second reduction in cycle time for a particular task performed by the robots 114a-n of the robotic operating environment 110 will be awarded a particular amount of money (e.g., $1,000/second). If in response to the optimization challenge, a developer 150c submits a robotic control plan 152c that reduces the cycle time by three seconds, as determined based on execution in the digital representation 122 of the validation system 120, the robotic control plan 152c is identified as valid and is provided to the robotic operating environment 110. In response, the validation system 120 can facilitate payment of the award defined in the optimization challenge to the developer 150c. For example, payment in the amount of $3,000 ($1,000 for each of the three seconds of cycle time reduction provided by robotic control plan 152c) can be transferred from the owner of the robotic operating environment 110 to the developer 150c of the selected, optimized robotic control plan 152c.

The robot functionalities described in this specification can be implemented by a hardware-agnostic software stack, or, for brevity just a software stack, that is at least partially hardware-agnostic. In other words, the software stack can accept as input commands generated by the planning processes described above without requiring the commands to relate specifically to a particular model of robot or to a particular robotic component. For example, the software stack can be implemented at least partially by the robotic control system 150 of FIG. 1.

For example, referring to FIG. 1, candidate control plans 152a-c submitted by developers 150 to the validation system 120 can first be translated using a software stack of development service 136 into sequences of joint goals states, each expressed as position or velocity, at a given time, for each joint. As a result, each robot 124a-n in the digital representation 122 will follow the corresponding joint goal state sequence within the digital representation 122 during execution of the translated candidate robotic control plan 152 by the digital representation. This process of controlling operation of the robots 124a-c within the digital representation 122 using a software stack of the development service to translate the candidate robotic control plans 152a-c can be similar to software stack driven control of the robots 114a-n in the robotic operating environment 110, with the exception that simulated motor feedback controllers replace physical motor feedback controllers when controlling the robots 124a-c in the digital representation 120. The motions of the simulated robots 124a-n thus operated result in a validation run of the digital representation 122, which will result in a validated control plan if the target improvements defined in the optimization challenge are satisfied.

The software stack can include multiple levels of increasing hardware specificity in one direction and increasing software abstraction in the other direction. At the lowest level of the software stack are robot components that include devices that carry out low-level actions and sensors that report low-level statuses. For example, robotic components can include a variety of low-level components including motors, encoders, cameras, drivers, grippers, application-specific sensors, linear or rotary position sensors, and other peripheral devices. As one example, a motor can receive a command indicating an amount of torque that should be applied. In response to receiving the command, the motor can report a current position of a joint of the robot, e.g., using an encoder, to a higher level of the software stack.

Each next highest level in the software stack can implement an interface that supports multiple different underlying implementations. In general, each interface between levels provides status messages from the lower level to the upper level and provides commands from the upper level to the lower level.

Typically, the commands and status messages are generated cyclically during each control cycle, e.g., one status message and one command per control cycle. Lower levels of the software stack generally have tighter real-time requirements than higher levels of the software stack. At the lowest levels of the software stack, for example, the control cycle can have actual real-time requirements. In this specification, real-time means that a command received at one level of the software stack must be executed and optionally, that a status message be provided back to an upper level of the software stack, within a particular control cycle time. If this real-time requirement is not met, the robot can be configured to enter a fault state, e.g., by freezing all operation.

At a next-highest level, the software stack can include software abstractions of particular components, which will be referred to motor feedback controllers. A motor feedback controller can be a software abstraction of any appropriate lower-level components and not just a literal motor. A motor feedback controller thus receives state through an interface into a lower-level hardware component and sends commands back down through the interface to the lower-level hardware component based on upper-level commands received from higher levels in the stack. A motor feedback controller can have any appropriate control rules that determine how the upper-level commands should be interpreted and transformed into lower-level commands. For example, a motor feedback controller can use anything from simple logical rules to more advanced machine learning techniques to transform upper-level commands into lower-level commands. Similarly, a motor feedback controller can use any appropriate fault rules to determine when a fault state has been reached. For example, if the motor feedback controller receives an upper-level command but does not receive a lower-level status within a particular portion of the control cycle, the motor feedback controller can cause the robot to enter a fault state that ceases all operations.

At a next-highest level, the software stack can include actuator feedback controllers. An actuator feedback controller can include control logic for controlling multiple robot components through their respective motor feedback controllers. For example, some robot components, e.g., a joint arm, can actually be controlled by multiple motors. Thus, the actuator feedback controller can provide a software abstraction of the joint arm by using its control logic to send commands to the motor feedback controllers of the multiple motors.

At a next-highest level, the software stack can include joint feedback controllers. A joint feedback controller can represent a joint that maps to a logical degree of freedom in a robot. Thus, for example, while a wrist of a robot might be controlled by a complicated network of actuators, a joint feedback controller can abstract away that complexity and expose that degree of freedom as a single joint. Thus, each joint feedback controller can control an arbitrarily complex network of actuator feedback controllers. As an example, a six degree-of-freedom robot can be controlled by six different joint feedback controllers that each control a separate network of actual feedback controllers.

Each level of the software stack can also perform enforcement of level-specific constraints. For example, if a particular torque value received by an actuator feedback controller is outside of an acceptable range, the actuator feedback controller can either modify it to be within range or enter a fault state.

To drive the input to the joint feedback controllers, the software stack can use a command vector that includes command parameters for each component in the lower levels, e.g., a position, torque, and velocity, for each motor in the system. To expose status from the joint feedback controllers, the software stack can use a status vector that includes status information for each component in the lower levels, e.g., a position, velocity, and torque for each motor in the system. In some implementations, the command vectors also include some limit information regarding constraints to be enforced by the controllers in the lower levels.

At a next-highest level, the software stack can include joint collection controllers. A joint collection controller can handle issuing of command and status vectors that are exposed as a set of part abstractions. Each part can include a kinematic model, e.g., for performing inverse kinematic calculations, limit information, as well as a joint status vector and a joint command vector. For example, a single joint collection controller can be used to apply different sets of policies to different subsystems in the lower levels. The joint collection controller can effectively decouple the relationship between how the motors are physically represented and how control policies are associated with those parts. Thus, for example if a robot arm has a movable base, a joint collection controller can be used to enforce a set of limit policies on how the arm moves and to enforce a different set of limit policies on how the movable base can move.

At a next-highest level, the software stack can include joint selection controllers. A joint selection controller can be responsible for dynamically selecting between commands being issued from different sources. In other words, a joint selection controller can receive multiple commands during a control cycle and select one of the multiple commands to be executed during the control cycle. The ability to dynamically select from multiple commands during a real-time control cycle allows greatly increased flexibility in control over conventional robot control systems.

At a next-highest level, the software stack can include joint position controllers. A joint position controller can receive goal parameters and dynamically compute commands required to achieve the goal parameters. For example, a joint position controller can receive a position goal and can compute a set point for achieving the goal.

At a next-highest level, the software stack can include Cartesian position controllers and Cartesian selection controllers. A Cartesian position controller can receive as input goals in Cartesian space and use inverse kinematics solvers to compute an output in joint position space. The Cartesian selection controller can then enforce limit policies on the results computed by the Cartesian position controllers before passing the computed results in joint position space to a joint position controller in the next lowest level of the stack. For example, a Cartesian position controller can be given three separate goal states in Cartesian coordinates x, y, and z. For some degrees, the goal state could be a position, while for other degrees, the goal state could be a desired velocity.

These functionalities afforded by the software stack thus provide wide flexibility for control directives to be easily expressed as goal states in a way that meshes naturally with the higher-level planning techniques described above. In other words, when the planning process uses a process definition graph to generate concrete actions to be taken, the actions need not be specified in low-level commands for individual robotic components. Rather, they can be expressed as high-level goals that are accepted by the software stack that get translated through the various levels until finally becoming low-level commands. Moreover, the actions generated through the planning process can be specified in Cartesian space in a way that makes them understandable for human operators, which makes debugging and analyzing the schedules easier, faster, and more intuitive. In addition, the actions generated through the planning process need not be tightly coupled to any particular robot model or low-level command format. Instead, the same actions generated during the planning process can actually be executed by different robot models so long as they support the same degrees of freedom and the appropriate control levels have been implemented in the software stack.

A distributed ledger system can be used to record and track information related to validation of candidate robotic control plans submitted to the validation system 120 in response to an optimization challenge. For example, upon validation of a candidate robotic control plan 152a-c by the validation system 120, the validated control plan can be transmitted to a distributed ledger system and, if all nodes of the distributed ledger system confirm that the plan in validated, the distributed ledger system can record that the plan is validated. In addition, a distributed ledger system can also be used to record the developer 150c who generated the validated robotic control plan 152c in order to ensure proper credit is given to the developer 152c.

A distributed ledger system can also be used to securely provide payment to the developer 150c who submitted the “winning” robotic control plan 152c identified as best optimizing the robotic task defined in the optimization challenge. For example, an operator 170 of the robotic operating environment 110 can specify that each one second reduction in cycle time will be awarded a particular amount of money (e.g., $1,000/second). If developer 150c submits a candidate robotic control plan 152c that reduces the cycle time by three seconds, as determined based on execution of the robotic control plan 152c in the digital representations 122 of the robotic operating environment 110, the distributed ledger system can generate an e-contract between the owner of the robotic operating environment 110 and the developer 150c who contributed the “winning” robotic control plan 152c transmitted to and implemented in the robotic operating environment 110. As a result, the distributed ledger system can be used to ensure payment is transferred from the owner of the robotic operating environment 110 implementing the optimized robotic control plan 152 c to the developer 150c of the optimized robotic control plan 152c.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML, page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method performed by one or more computers, the method comprising:

obtaining, by a validation platform system, data representing an optimization challenge for a task to be performed by one or more robots in a robotic operating environment, wherein the optimization challenge has one or more associated goal criteria for the task to be performed by the one or more robots in the robotic operating environment to be optimized,

and wherein the optimization challenge is associated with a digital representation of the robotic operating environment that obscures one or more elements in the robotic operating environment;

providing, by the validation platform system to a development platform system operated by a different entity than the validation platform system, information related to the optimization challenge, the information comprising a target improvement and the digital representation of the robotic operating environment;

obtaining, by the validation platform system from the development platform system, a candidate robotic control plan;

executing, by the validation platform system, the candidate robotic control plan using the digital representation of the robotic operating environment;

determining, based on the execution of the candidate robotic control plan using the digital representation, that the candidate robotic control plan is valid according to the one or more goal criteria; and

in response, providing, by the validation platform system to the robotic operating environment, the valid robotic control plan for deployment in the robotic operating environment.

Embodiment 2 is the method of embodiment 1, further comprising:
obtaining, by the validation platform system from the development platform system, a plurality of candidate robotic control plans;
executing, by the validation platform system, each of the plurality of candidate robotic control plans using the digital representation of the robotic operating environment;
determining, based on execution of each of the plurality of candidate robotic control plans using the digital representation, a valid candidate robotic control plan from the plurality of candidate robotic control plans that best satisfies the one or more goal criteria; and
transmitting the valid robotic control plan that best satisfies the one or more goal criteria to the robotic operating environment for execution by the one or more robots in the robotic operating environment.

Embodiment 3 is the method of embodiment 2, wherein determining, based on execution of each of the plurality of candidate robotic control plans using the digital representation, a valid candidate robotic control plan from the plurality of candidate robotic control plans that best satisfies the one or more goal criteria comprises:

determining, by the validation platform system based on the data representing the optimization challenge, a current operating metric for the task to be performed by the one or more robots in the robotic operating environment to be optimized;

executing, by the validation platform system, each of the plurality of candidate robotic control plans using the digital representation of the robotic operating environment;

comparing an operating metric for the task generated by execution of each respective candidate robotic control plans using the digital representation to the current operating metric for the task; and

based on the comparison, identifying a valid robotic control plan from the plurality of candidate robotic control plans that best satisfies the one or more goal criteria.

Embodiment 4 is the method of any one of embodiments 1-3, wherein the one or more goal criteria specify one or more values of one or more corresponding operating metrics defining when a candidate robotic control plan is a valid solution to the optimization challenge.

Embodiment 5 is the method of any one of embodiments 1-4, wherein the one or more goal criteria specify an operating metric to be optimized, the operating metric comprising at least one of cycle time, energy usage, space utilization, error rates, or robot wear.

Embodiment 6 is the method of any one of embodiments 1-5, further comprising:

recording, by a distributed ledger system, that the valid robotic control plan is valid according to the one or more goal criteria.

Embodiment 7 is the method of any one of embodiments 1-6, wherein:

obtaining data representing the optimization challenge for the task to be performed by the one or more robots in the robotic operating environment comprises obtaining, by the validation platform system, data manually entered into a user interface of the validation platform system by an operator of the one or more robots in the robotic operating environment; and

the digital representation of the robotic operating environment is generated based on the data manually entered into a user interface of the validation platform system by the operator of the one or more robots in the robotic operating environment.

Embodiment 8 is the method of any one of embodiments 1-7, wherein:

obtaining data representing the optimization challenge for the task to be performed by the one or more robots in the robotic operating environment comprises obtaining, by a validation platform system from an operator of the one or more robots in the robotic operating environment, a preexisting digital model of the robotic operating environment stored on a computing system of the robotic operating environment; and

the digital representation of the robotic operating environment is generated based on the preexisting digital model of the robotic operating environment stored on the computing system of the robotic operating environment.

Embodiment 9 is the method of any one of embodiments 1-8, wherein obtaining data representing the optimization challenge for the task to be performed by the one or more robots in the robotic operating environment comprises:

obtaining, by the validation platform system from a computing system of the robotic operating environment, information regarding a plurality of robotic tasks performed by the one or more robots in the robotic operating environment;

identifying, by the validation platform system, one or more robotic tasks of the plurality of robotic tasks as one or more candidate tasks for optimization;

presenting, by the validation platform system to an operator of the one or more robots of the robotic operating environment, the one or more candidate tasks; and

receiving, by the validation platform system from the operator of the one or more robots of the robotic operating environment, a selection of a particular task from the one or more candidate tasks.

Embodiment 10 is a system comprising: one or more processors; and a non-transitory storage medium storing computer instructions operable to cause the one or more processors to perform the method of any one of embodiments 1-9.

Embodiment 11 is a computer-readable storage medium comprising instructions that, when executed by one or more computers, cause the one or more computers to perform the method of any one of embodiments 1-9.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers, the method comprising:
obtaining, by a validation platform system, data representing an optimization challenge for a task to be performed by one or more robots in a robotic operating environment, wherein the optimization challenge has one or more associated goal criteria for the task to be performed by the one or more robots in the robotic operating environment to be optimized,
and wherein the optimization challenge is associated with a digital representation of the robotic operating environment that obscures one or more elements in the robotic operating environment;
providing, by the validation platform system to a development platform system operated by a different entity than the validation platform system, information related to the optimization challenge, the information comprising a target improvement and the digital representation of the robotic operating environment;
obtaining, by the validation platform system from the development platform system, a candidate robotic control plan;
executing, by the validation platform system, the candidate robotic control plan using the digital representation of the robotic operating environment;
determining, based on the execution of the candidate robotic control plan using the digital representation, that the candidate robotic control plan is valid according to the one or more goal criteria; and
in response, providing, by the validation platform system to the robotic operating environment, the valid robotic control plan for deployment in the robotic operating environment.

2. The method of claim 1, further comprising:
obtaining, by the validation platform system from the development platform system, a plurality of candidate robotic control plans;
executing, by the validation platform system, each of the plurality of candidate robotic control plans using the digital representation of the robotic operating environment;
determining, based on execution of each of the plurality of candidate robotic control plans using the digital representation, a valid candidate robotic control plan from the plurality of candidate robotic control plans that best satisfies the one or more goal criteria; and
transmitting the valid robotic control plan that best satisfies the one or more goal criteria to the robotic operating environment for execution by the one or more robots in the robotic operating environment.

3. The method of claim 2, wherein determining, based on execution of each of the plurality of candidate robotic control plans using the digital representation, a valid candidate robotic control plan from the plurality of candidate robotic control plans that best satisfies the one or more goal criteria comprises:
determining, by the validation platform system based on the data representing the optimization challenge, a current operating metric for the task to be performed by the one or more robots in the robotic operating environment to be optimized;
executing, by the validation platform system, each of the plurality of candidate robotic control plans using the digital representation of the robotic operating environment;
comparing an operating metric for the task generated by execution of each respective candidate robotic control plans using the digital representation to the current operating metric for the task; and
based on the comparison, identifying a valid robotic control plan from the plurality of candidate robotic control plans that best satisfies the one or more goal criteria.

4. The method of claim 1, wherein the one or more goal criteria specify one or more values of one or more corresponding operating metrics defining when a candidate robotic control plan is a valid solution to the optimization challenge.

5. The method of claim 1, wherein the one or more goal criteria specify an operating metric to be optimized, the operating metric comprising at least one of cycle time, energy usage, space utilization, error rates, or robot wear.

6. The method of claim 1, further comprising:
recording, by a distributed ledger system, that the valid robotic control plan is valid according to the one or more goal criteria.

7. The method of claim 1, wherein:
obtaining data representing the optimization challenge for the task to be performed by the one or more robots in the robotic operating environment comprises obtaining, by the validation platform system, data manually entered into a user interface of the validation platform system by an operator of the one or more robots in the robotic operating environment; and
the digital representation of the robotic operating environment is generated based on the data manually entered into a user interface of the validation platform system by the operator of the one or more robots in the robotic operating environment.

8. The method of claim 1, wherein:
obtaining data representing the optimization challenge for the task to be performed by the one or more robots in the robotic operating environment comprises obtaining, by a validation platform system from an operator of the one or more robots in the robotic operating environment, a preexisting digital model of the robotic operating environment stored on a computing system of the robotic operating environment; and
the digital representation of the robotic operating environment is generated based on the preexisting digital model of the robotic operating environment stored on the computing system of the robotic operating environment.

9. The method of claim 1, wherein obtaining data representing the optimization challenge for the task to be performed by the one or more robots in the robotic operating environment comprises:
obtaining, by the validation platform system from a computing system of the robotic operating environment, information regarding a plurality of robotic tasks performed by the one or more robots in the robotic operating environment;
identifying, by the validation platform system, one or more robotic tasks of the plurality of robotic tasks as one or more candidate tasks for optimization;
presenting, by the validation platform system to an operator of the one or more robots of the robotic operating environment, the one or more candidate tasks; and
receiving, by the validation platform system from the operator of the one or more robots of the robotic operating environment, a selection of a particular task from the one or more candidate tasks.

10. A system comprising:
one or more processors; and
a non-transitory storage medium storing computer instructions operable to cause the one or more processors to perform operations comprising:
obtaining, by a validation platform system, data representing an optimization challenge for a task to be performed by one or more robots in a robotic operating environment, wherein the optimization challenge has one or more associated goal criteria for the task to be performed by the one or more robots in the robotic operating environment to be optimized,
and wherein the optimization challenge is associated with a digital representation of the robotic operating environment that obscures one or more elements in the robotic operating environment;
providing, by the validation platform system to a development platform system operated by a different entity than the validation platform system, information related to the optimization challenge, the information comprising a target improvement and the digital representation of the robotic operating environment;
obtaining, by the validation platform system from the development platform system, a candidate robotic control plan;
executing, by the validation platform system, the candidate robotic control plan using the digital representation of the robotic operating environment;
determining, based on the execution of the candidate robotic control plan using the digital representation, that the candidate robotic control plan is valid according to the one or more goal criteria; and
in response, providing, by the validation platform system to the robotic operating environment, the valid robotic control plan for deployment in the robotic operating environment.

11. The system of claim 10, wherein the operations further comprise:
obtaining, by the validation platform system from the development platform system, a plurality of candidate robotic control plans;
executing, by the validation platform system, each of the plurality of candidate robotic control plans using the digital representation of the robotic operating environment;
determining, based on execution of each of the plurality of candidate robotic control plans using the digital representation, a valid candidate robotic control plan from the plurality of candidate robotic control plans that best satisfies the one or more goal criteria; and
transmitting the valid robotic control plan that best satisfies the one or more goal criteria to the robotic operating environment for execution by the one or more robots in the robotic operating environment.

12. The system of claim 11, wherein determining, based on execution of each of the plurality of candidate robotic control plans using the digital representation, a valid candidate robotic control plan from the plurality of candidate robotic control plans that best satisfies the one or more goal criteria comprises:
determining, by the validation platform system based on the data representing the optimization challenge, a current operating metric for the task to be performed by the one or more robots in the robotic operating environment to be optimized;
executing, by the validation platform system, each of the plurality of candidate robotic control plans using the digital representation of the robotic operating environment;
comparing an operating metric for the task generated by execution of each respective candidate robotic control plans using the digital representation to the current operating metric for the task; and
based on the comparison, identifying a valid robotic control plan from the plurality of candidate robotic control plans that best satisfies the one or more goal criteria.

13. The system of claim 10, wherein the one or more goal criteria specify one or more values of one or more corresponding operating metrics defining when a candidate robotic control plan is a valid solution to the optimization challenge.

14. The system of claim 10, wherein the one or more goal criteria specify an operating metric to be optimized, the operating metric comprising at least one of cycle time, energy usage, space utilization, error rates, or robot wear.

15. The system of claim 10, wherein the operations further comprise:
recording, by a distributed ledger system, that the valid robotic control plan is valid according to the one or more goal criteria.

16. The system of claim 10, wherein:
obtaining data representing the optimization challenge for the task to be performed by the one or more robots in the robotic operating environment comprises obtaining, by the validation platform system, data manually entered into a user interface of the validation platform system by an operator of the one or more robots in the robotic operating environment; and
the digital representation of the robotic operating environment is generated based on the data manually entered into a user interface of the validation platform system by the operator of the one or more robots in the robotic operating environment.

17. The system of claim 10, wherein:
obtaining data representing the optimization challenge for the task to be performed by the one or more robots in the robotic operating environment comprises obtaining, by a validation platform system from an operator of the one or more robots in the robotic operating environment, a preexisting digital model of the robotic operating environment stored on a computing system of the robotic operating environment; and
the digital representation of the robotic operating environment is generated based on the preexisting digital model of the robotic operating environment stored on the computing system of the robotic operating environment.

18. The system of claim 10, wherein obtaining data representing the optimization challenge for the task to be performed by the one or more robots in the robotic operating environment comprises:
obtaining, by the validation platform system from a computing system of the robotic operating environment, information regarding a plurality of robotic tasks performed by the one or more robots in the robotic operating environment;
identifying, by the validation platform system, one or more robotic tasks of the plurality of robotic tasks as one or more candidate tasks for optimization;
presenting, by the validation platform system to an operator of the one or more robots of the robotic operating environment, the one or more candidate tasks; and
receiving, by the validation platform system from the operator of the one or more robots of the robotic operating environment, a selection of a particular task from the one or more candidate tasks.

19. A computer-readable storage medium comprising instructions that, when executed by one or more computers, cause the one or more computers to perform operations comprising:
obtaining, by a validation platform system, data representing an optimization challenge for a task to be performed by one or more robots in a robotic operating environment, wherein the optimization challenge has one or more associated goal criteria for the task to be performed by the one or more robots in the robotic operating environment to be optimized,
and wherein the optimization challenge is associated with a digital representation of the robotic operating environment that obscures one or more elements in the robotic operating environment;
providing, by the validation platform system to a development platform system operated by a different entity than the validation platform system, information related to the optimization challenge, the information comprising a target improvement and the digital representation of the robotic operating environment;
obtaining, by the validation platform system from the development platform system, a candidate robotic control plan;
executing, by the validation platform system, the candidate robotic control plan using the digital representation of the robotic operating environment;
determining, based on the execution of the candidate robotic control plan using the digital representation, that the candidate robotic control plan is valid according to the one or more goal criteria; and
in response, providing, by the validation platform system to the robotic operating environment, the valid robotic control plan for deployment in the robotic operating environment.

20. The computer-readable storage medium of claim 19, wherein the operations further comprise:
obtaining, by the validation platform system from the development platform system, a plurality of candidate robotic control plans;
executing, by the validation platform system, each of the plurality of candidate robotic control plans using the digital representation of the robotic operating environment;
determining, based on execution of each of the plurality of candidate robotic control plans using the digital representation, a valid candidate robotic control plan from the plurality of candidate robotic control plans that best satisfies the one or more goal criteria; and
transmitting the valid robotic control plan that best satisfies the one or more goal criteria to the robotic operating environment for execution by the one or more robots in the robotic operating environment.

21. The computer-readable storage medium of claim 20, wherein determining, based on execution of each of the plurality of candidate robotic control plans using the digital representation, a valid candidate robotic control plan from the plurality of candidate robotic control plans that best satisfies the one or more goal criteria comprises:
determining, by the validation platform system based on the data representing the optimization challenge, a current operating metric for the task to be performed by the one or more robots in the robotic operating environment to be optimized;
executing, by the validation platform system, each of the plurality of candidate robotic control plans using the digital representation of the robotic operating environment;
comparing an operating metric for the task generated by execution of each respective candidate robotic control plans using the digital representation to the current operating metric for the task; and
based on the comparison, identifying a valid robotic control plan from the plurality of candidate robotic control plans that best satisfies the one or more goal criteria.

22. The computer-readable storage medium of claim 19, wherein the one or more goal criteria specify one or more values of one or more corresponding operating metrics defining when a candidate robotic control plan is a valid solution to the optimization challenge.

23. The computer-readable storage medium of claim 19, wherein the one or more goal criteria specify an operating metric to be optimized, the operating metric comprising at least one of cycle time, energy usage, space utilization, error rates, or robot wear.

24. The computer-readable storage medium of claim 19, wherein the operations further comprise:
recording, by a distributed ledger system, that the valid robotic control plan is valid according to the one or more goal criteria.

25. The computer-readable storage medium of claim 19, wherein:
obtaining data representing the optimization challenge for the task to be performed by the one or more robots in the robotic operating environment comprises obtaining, by a validation platform system from an operator of the one or more robots in the robotic operating environment, a preexisting digital model of the robotic operating environment stored on a computing system of the robotic operating environment; and
the digital representation of the robotic operating environment is generated based on the preexisting digital model of the robotic operating environment stored on the computing system of the robotic operating environment.
